(19) United States
(12) Patent Application Publication
(10) Pub. No.: US 2025/0136284 A1
(43) Pub. Date: May 1, 2025

(54) DEPLOYABLE UTILITY SURFACE WITH ABUSE LOAD BREAKOVER

(71) Applicant: Adient Aerospace, LLC, Bothell, WA (US)

(72) Inventor: Neal Silverwood, Cardiff (GB)

(21) Appl. No.: 18/915,520

(22) Filed: Oct. 15, 2024

Related U.S. Application Data
(60) Provisional application No. 63/594,159, filed on Oct. 30, 2023.

(51) Int. Cl. B64D 11/06

(52) U.S. Cl. CPC B64D 11/0638; B64D 11/0605

(57) ABSTRACT

A utility surface assembly for passenger use while seated in a vehicle, in particular an aircraft cabin, is integrated into a support structure such as furniture surrounding a passenger seat. The utility surface slides out from the furniture toward the passenger seat in drawer-like fashion and is restowed by sliding the utility surface back into the furniture. The assembly includes a breakaway hinge that prevents accidental damage to the utility surface in the event it is overloaded. In the event excessive force is applied, the utility surface breaks away without the applied force causing damage to the assembly. Because of the breakaway feature, the utility surface can be restowed without obstructing a passenger's safe egress. The assembly is also configured as a vanity mirror for passenger use.

### CROSS-REFERENCE TO RELATED APPLICATION

This application claims the benefit of U.S. Provisional Patent Application Ser. No. 63/594,159, filed Oct. 30, 2023, and entitled “Deployable Utility Surface with Abuse Load Breakover,” which is incorporated herein by reference in its entirety.

### FIELD

This disclosure relates to aircraft and more particularly to a deployable utility surface for passenger use.

### BACKGROUND

An aircraft cabin is provided with a variety of conveniences. For example, passenger seats are provided with surrounding furniture incorporating tabletops, stowage compartments, consoles, utility surfaces, in-flight entertainment monitors, privacy walls, and the like. There is a continuing effort to improve passenger comfort, sleeping and productivity and to offer new features and amenities to passengers to further accommodate their needs and increase the level of luxury. One such amenity is a deployable utility surface. A utility surface can be designed for a variety of functions to serve passengers and crew members. A utility surface can be a convenient location for placing objects. Also, a utility surface may include other convenience features such as vanity mirror. A passenger or crew member can conveniently use a deployable vanity mirror to view their reflection to apply makeup and adjust hair while remaining seated without visiting the aircraft restroom or having to retrieve their own mirror from carry-on luggage.

The inclusion of a deployable utility surface in the passenger seating area comes with additional cost, weight, complexity and space requirements. Ideal locations for providing a utility surface such as a mirror in the passenger seating area are limited. A vanity mirror is most convenient when placed directly in front of the passenger seat. However, a backrest of another seat and an in-flight entertainment monitor typically occupy the vertical surface directly in front of the passenger. Other vertical surfaces in the passenger compartment for mounting a mirror may not be at the right angle or location for convenient use of a mirror while a passenger is seated with limited mobility. Also, aircraft safety requirements during taxi, take-off, and landing, require any elements of seating furniture that extend towards the passenger seat or exit pathway to be securely stowed out of the way to clear the passenger's exit pathway. Deployable utility surfaces are described herein that meet the expectations for passenger use while maximizing the use of space and meeting airline safety requirements.

### SUMMARY

In accordance with one or more examples, an assembly includes a housing having an opening, the housing configured to attach to a support structure, a tray connected to the housing and configured to slide laterally through the opening between a stowed tray position and a deployed tray position, and a mirror connected to the tray and configured to rotate relative to the tray, when in the deployed tray position, from a stowed mirror position to a deployed mirror position in which the mirror is positioned at an angle with respect to the tray.

In accordance with one or more examples, an assembly comprising a housing connected to a support structure, a tray connected to the housing and configured to slide laterally relative to the housing between a stowed tray position and a deployed tray position, and a breakaway hinge coupling together the housing and the tray, wherein the breakaway hinge is operable to release the tray from the deployed tray position to a hanging breakaway tray position upon application of an abuse load to the tray such that at least a portion of the tray hangs downwardly relative to the housing.

In accordance with one or more examples, an assembly comprising at least one passenger seat, a support structure adjacent to the passenger seat defining an egress pathway between the passenger seat, and at least one breakaway tray assembly connected to the support structure, the breakaway tray assembly comprising a tray movable from a stowed tray position to a deployed tray position in which the tray extends into the egress pathway, and a breakaway hinge operable to release the tray from the deployed tray position to a hanging breakaway tray position upon application of an abuse load to the tray.

The features, functions, and advantages that have been discussed can be achieved independently in various examples or can be combined in yet other examples further details of which can be seen with reference to the following description and drawings.

### DESCRIPTION OF THE DRAWINGS

The various advantages of the examples of the present disclosure will become apparent to one skilled in the art by reading the following specification and appended claims, and by referencing the following drawings in which:

FIG. 1A shows a top perspective view of a vanity mirror in a deployed mirror position with respect to an aircraft passenger console, according to one or more examples;

FIG. 1B shows a top perspective view of a vanity mirror in a stowed tray position within an aircraft passenger console, according to one or more examples;

FIG. 1C shows a top perspective view of a vanity mirror in a deployed tray position with respect to an aircraft passenger console, according to one or more examples;

FIG. 2 shows schematically a top view of a seating arrangement for an aircraft cabin with a plurality of deployable vanity mirrors, according to one or more examples;

FIG. 3 shows schematically a top view of a center seating arrangement for a vehicle cabin, in particular an aircraft cabin, having with two tabletops each having a deployable utility surface, according to one or more examples;

FIG. 4 shows an exploded view of a tray assembly, according to one or more examples;

FIG. 5A shows a top perspective view of a mirror assembly in an undeployed position, according to one or more examples;

FIG. 5B shows a bottom perspective view of a mirror assembly in an undeployed position, according to one or more examples;

FIG. 5C shows a side view of a mirror assembly in an undeployed position, according to one or more examples;

FIG. 5D shows a bottom view of a mirror assembly in an undeployed position, according to one or more examples;

FIG. 5E shows an end view of a mirror assembly in an undeployed position, according to one or more examples;

FIG. 5F shows a cross-sectional view taken along line 5F-5F of FIG. 5D of a mirror assembly in an undeployed position, according to one or more examples;

FIG. 5G shows a detail view of detail 5G of FIG. 5F of a mirror assembly in an undeployed position, according to one or more examples;

FIG. 6A shows a top perspective view of a mirror assembly in a fully deployed position, according to one or more examples;

FIG. 6B shows a side view of a mirror assembly in a fully deployed position, according to one or more examples;

FIG. 6C shows a top view of a mirror assembly in a fully deployed position, according to one or more examples;

FIG. 6D shows a cross-sectional view taken along line 6D-6D of FIG. 6C of a mirror assembly in a fully deployed position, according to one or more examples;

FIG. 7A shows a fragmentary top perspective and partially transparent view of a breakaway connection of a mirror assembly, according to one or more examples;

FIG. 7B shows a fragmentary top perspective view of a mirror assembly in a breakover position, according to one or more examples;

FIG. 8A shows schematically, a side view of a mirror assembly in a partially deployed position, an intermediate breakover position, and a full breakover position, according to one or more examples;

FIG. 8B shows schematically, a side view of a mirror assembly in a fully deployed position, an intermediate breakover position, and a full breakover position, according to one or more examples;

FIG. 9 shows a fragmentary top perspective sectional view of a detent sub-assembly of a mirror assembly, according to one or more examples;

FIG. 10 shows a bottom perspective and exploded view of a mirror assembly and a tabletop assembly, according to one or more examples;

FIG. 11A shows a perspective view of a mirror assembly in a fully deployed position with respect to a passenger seating console, according to one or more examples;

FIG. 11B shows a perspective view of the mirror assembly of FIG. 11A in a breakover position with respect to a passenger seating console, according to one or more examples;

FIG. 12A shows a perspective view of a mirror assembly in a fully deployed position with respect to a passenger seating console, according to one or more examples; and

FIG. 12B shows a perspective view of the mirror assembly of FIG. 12A in a breakover position with respect to a passenger seating console, according to one or more examples.

### DETAILED DESCRIPTION

In the following detailed description of the examples, numerous specific details are set forth in order to provide a more thorough understanding of the one or more examples. However, it will be apparent to one of ordinary skill in the art that the one or more examples can be practiced without these specific details. In other instances, well-known features have not been described in detail to avoid unnecessarily complicating the description.

A utility surface is deployable for use by a passenger while seated in a vehicle, in particular an aircraft cabin. The utility surface is part of an assembly that is integrated into a support structure such as furniture that surrounds a passenger seat. The utility surface slides out from the support structure toward the passenger seat in drawer-like fashion. The utility surface may then be employed by the passenger to place objects. In one variation, the assembly is configured to provide the passenger with a vanity mirror. The vanity mirror slides out from the support structure and flips up into an angle suitable for passenger use. The mirror is restowed by flipping the mirror down and sliding the mirror back into the furniture. The assembly includes a breakaway feature that prevents accidental damage to the utility surface/mirror in the event it is accidentally overloaded when deployed. In the event excessive force is applied to the utility surface/mirror when deployed, the utility surface/mirror will break away without the applied force causing damage to the assembly to the extent that it cannot be restowed. Because of the breakaway feature, the utility surface/mirror is configured such that it can be restowed without remaining in an obstructed position for the passenger's egress.

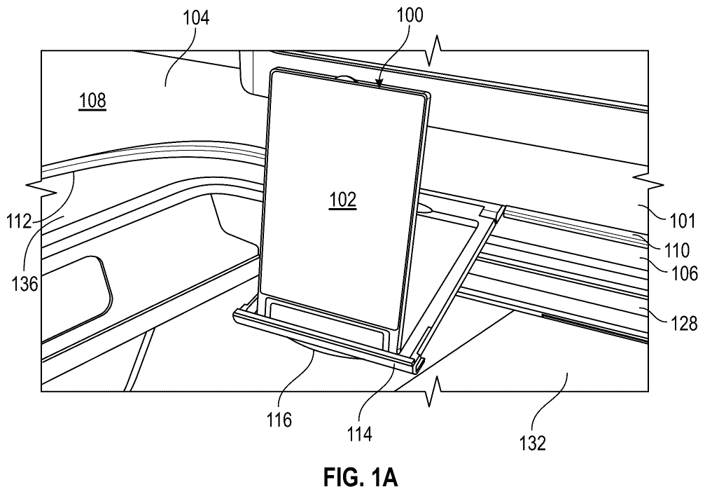

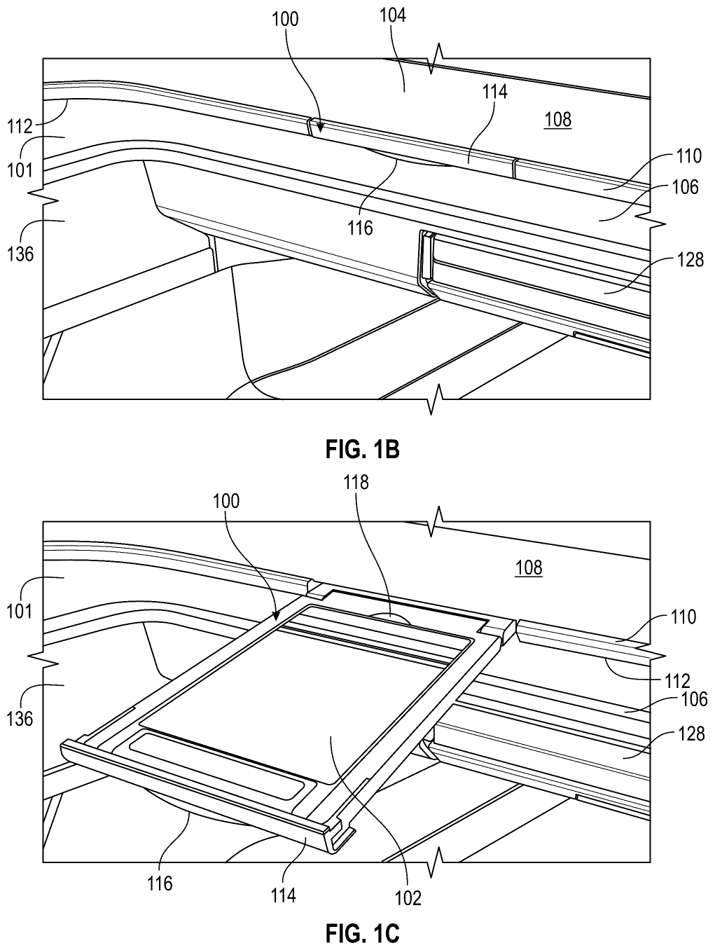

FIG. 1A illustrates a mirror assembly 100 including a mirror 102 in a fully deployed position. The mirror assembly 100 is connected to a support structure 101. An exemplary support structure 101 is an upper console 104 of cabin furniture 106 that surrounds a passenger seat. The upper console 104 is a planar layer, approximately one inch in thickness, integrated into the passenger cabin furniture 106. The upper console 104 is oriented horizontally and parallel to a floor 132 of the cabin. The upper console 104 can include an upper surface 108 that serves as a utility surface for placing objects. A front furniture surface 110 of the upper console 104 is interconnected between the upper surface 108 and a lower surface 112 of the upper console 104.

FIG. 1B shows the mirror assembly 100 in an undeployed or stowed position in which the mirror assembly 100 is stowed within the upper console 104 such that the mirror assembly 100 is retracted and, except for the front side 114 of the mirror assembly 100, concealed within the upper console 104. When in the stowed position, the front side 114 of the mirror assembly 100 is aligned and substantially flush with the outer surface 110 of the upper console 104. A first finger pull cavity 116 on the front side 114 of the mirror assembly 100 allows the passenger to manually pull the mirror assembly 100 out like a drawer from an opening formed in the upper console 104 into a deployed position.

FIG. 1C shows the mirror assembly 100 in a partially deployed or extended position in which the mirror 102 is pulled out from being aligned with the upper console 104. From the stowed position, the mirror assembly 100 is moved in a horizontal direction parallel to the upper console 104 and toward the passenger seat or passenger egress pathway. The egress pathway is between an aisle and the passenger seat. The mirror 102 translates horizontally until it reaches an extension limit and, at which point, it cannot be pulled out further with respect to the upper console 104. A second finger pull cavity 118 allows the mirror 102 to be manually rotated upwardly by the passenger into a fully-deployed position convenient for passenger use as shown in FIG. 1A.

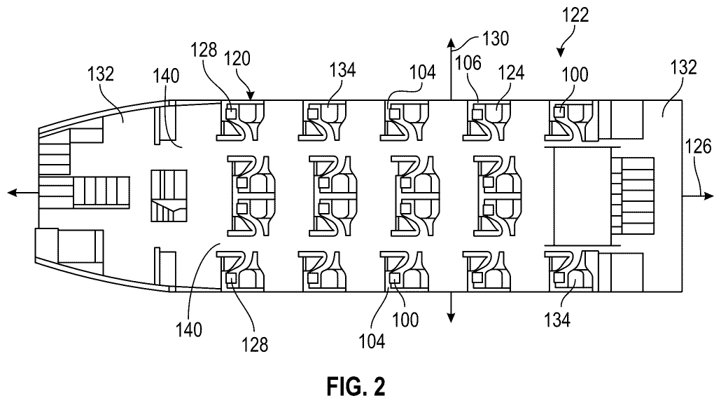

FIG. 2 shows an exemplary seating arrangement for a cabin 120 of an aircraft 122 comprising a plurality of seat units 124 arranged into four columns. The seat units 124 in each column are arranged one behind another along a longitudinal axis 126 of the cabin 120. Each seat 134 is a forward-facing seat 134. Any number of columns can be provided. A longitudinal axis of each seat in a column can be parallel to the longitudinal axis 126 of the cabin 120 or the longitudinal axis of each seat 134 can be angled relative to the longitudinal axis 126 of the cabin 120. A number of seats 134 in a column can be arranged in such a manner that a density of passenger seats 134 within the cabin 120 is optimized while providing a high comfort space for each passenger.

FIG. 2 is an example of a passenger seating arrangement in which each of the seat units 124 is provided with surrounding cabin furniture 106. Each seat unit 124 comprises one seat 134 and at least one of a console 104 and a tabletop 128 integrated into the cabin furniture 106. The passenger will enter the seat 134 from an aisle 140 via a passenger egress pathway. The console 104 can be an upper console 104 that is part of the cabin furniture 106 arranged at least partially and substantially alongside of the seat 134 for the corresponding passenger of the seat unit 124. The upper console 104 lies in a plane defined by a transverse axis 130 and the longitudinal axis 126. The upper console 104 is parallel to the cabin floor 132. The upper console 104 is integrated into the furniture 106 above a base element 136 (shown in FIGS. 1A-1C). The base element 136 extends and is connected to the cabin floor 132 of the cabin 120. The base element 136 can include retractable tabletops 128 (shown in FIGS. 1A-1C) as well as shelves, storage space, and service/operating elements such as switches for the control of operable features of the seat unit 124. Although shown as passenger furniture 106, any non-furniture support structure 101 is within the scope of variations where the mirror assembly 100 may be employed, including but not limited to other areas of the vehicle such as the galley, lounge, lavatory, and cockpit.

FIG. 2 illustrates each seat unit 124 provided with a vanity mirror assembly 100 extended out from a location in the cabin furniture 106 such as a console 104, tabletop 128, or other location in the furniture surrounding the seat unit 124. In the variation shown in FIG. 2, the vanity mirror 102 extends from a retracted location in the cabin furniture 106, in particular, an upper console 104, directly in front of the passenger seat 134, to an deployed position relative to the upper console 104 in which the vanity mirror 102 is translated towards the passenger scat 134 so that the vanity mirror 102 is deployable to face the front of the passenger. Because the vanity mirror 102 is located in front of the passenger and extends towards the passenger seat 134 or egress pathway when it is fully deployed, the passenger does not have to inconveniently adjust or angulate their body to view their reflection in the vanity mirror 102 while seated. The retracted position of the vanity mirror 102 into the cabin furniture 106 is referred to as a stowed or undeployed position. The vanity mirror 102 can be considered to be partially deployed until the vanity mirror 102 is fully extended and rotated with respect to the upper console 104 or tabletop 128 to face the passenger in a viewing position to define a fully deployed position as shown in FIG. 1A.

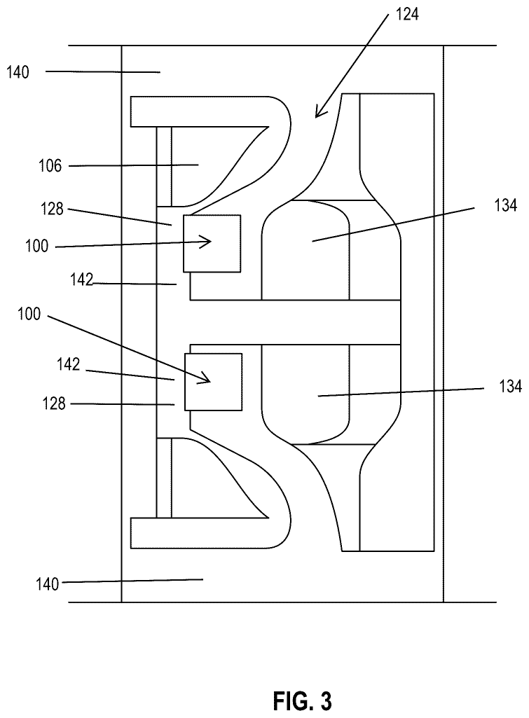

FIG. 3 illustrates an exemplary aircraft cabin seating arrangement 138 for the center two columns of passenger seats 134 having an aisle 140 on each side of the two columns. The seating arrangement 138 includes two forward-facing passenger seats 134 repeated along the longitudinal axis 126. The seating arrangement 138 includes two tabletops 128. The tabletops 128 are stowable and shown in their deployed configuration in FIG. 3. When in a deployed configuration, an upper surface 142 of the tabletop 128 lies in a plane defined by the longitudinal axis 126 and transverse axis 130 parallel to the cabin floor 132. The upper surface 142 of the tabletop 128 serves as a flat dining, utility or work surface for the passenger. The tabletop 128 is approximately one inch in thickness. Each tabletop 128 shown in FIG. 3 includes at least one mirror assembly 100 built into the tabletop 128. One mirror assembly 100 is arranged for the forward-facing passenger. Each mirror assembly 100 is located inside the tabletop 128 and extends from the tabletop 128 toward the passenger seat 134. One or more mirror assembly 100 can be incorporated into any tabletop 128 for any seating arrangement.

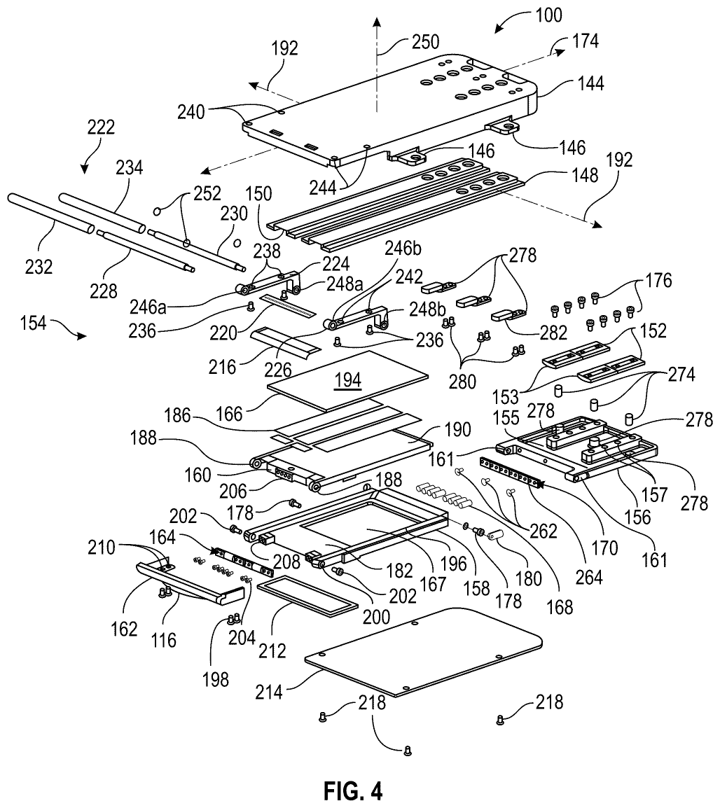

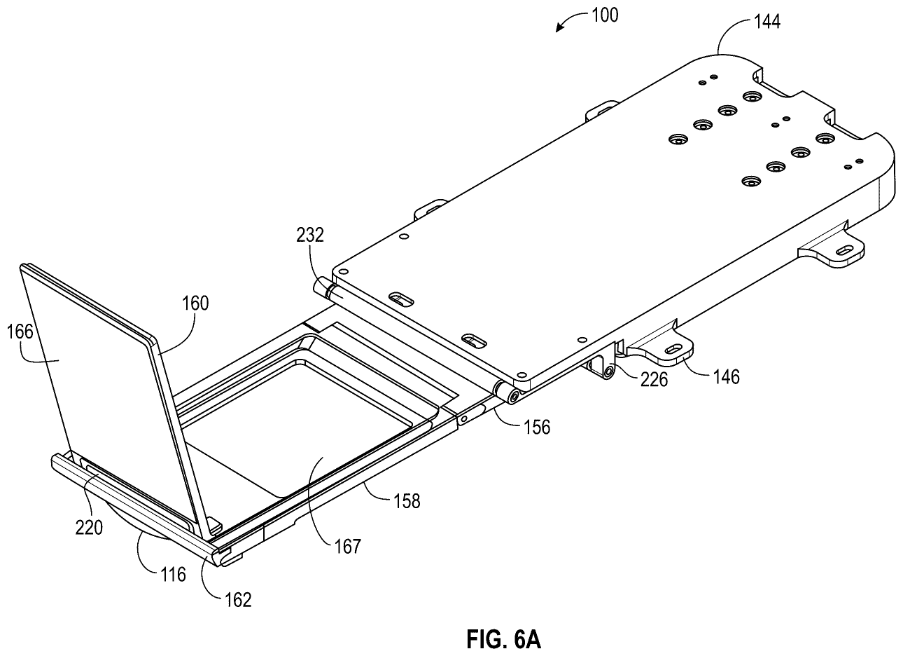

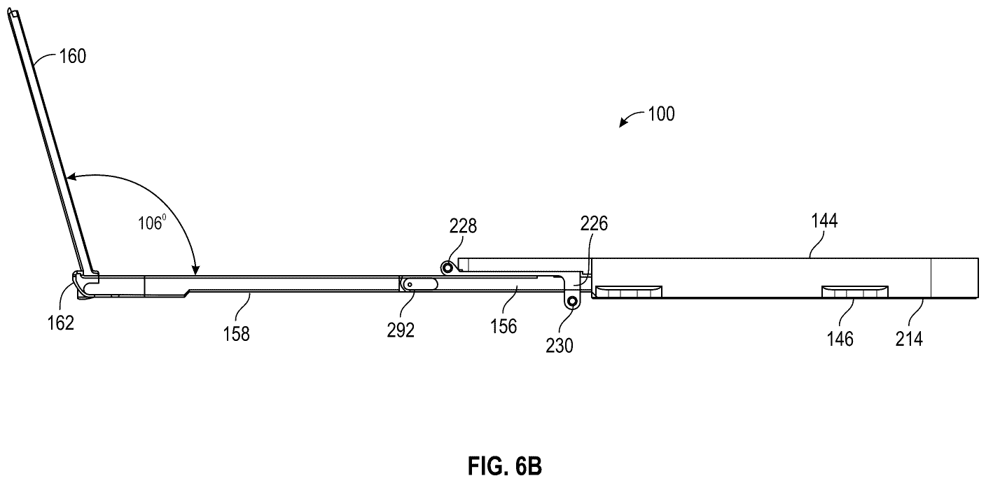

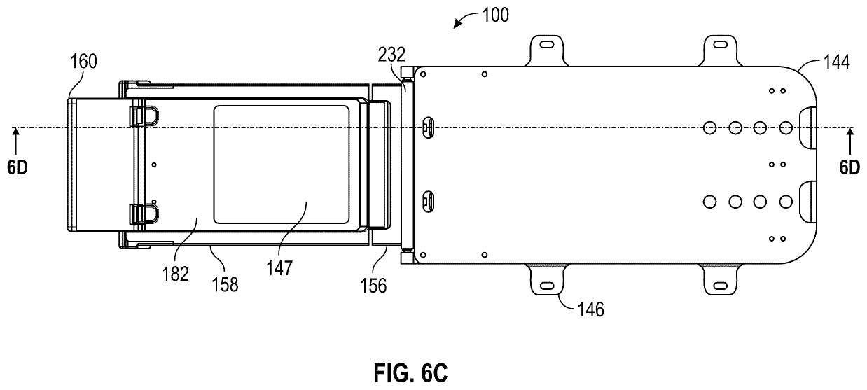

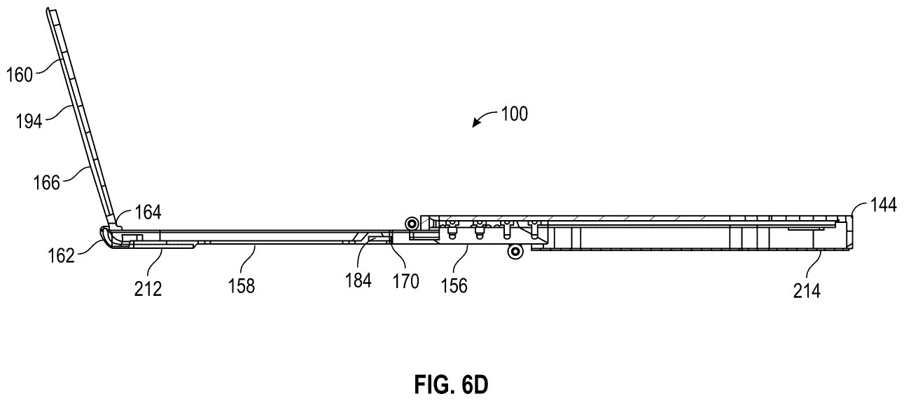

With reference to FIGS. 4, 5A-5G, and 6A-6D, the mirror assembly 100 be described in greater detail. The mirror assembly 100 includes a frame 144, a linear guide 148, a carriage 152, a mirror subassembly 154, a roller subassembly 222, a slider detent subassembly 172, and a cover 214. The cover 214 is attached to the frame 144 with cover fasteners 218 to form a rectangular, box-like, metal housing defining an interior with an open front end. The frame 144 includes mounting flanges 146 for attaching the mirror assembly 100 to a support structure 101 such as a tabletop 128, console 104 or other cabin furniture 106.

A linear guide 148 is bonded to the interior of the frame 144 using metal adhesive. The linear guide 148 comprises two parallel linear tracks 150 extending along a longitudinal axis 174 of the mirror assembly 100. A carriage, 152 comprising two parallel-oriented brackets 153, is slidingly inserted into the linear tracks 150 of the linear guide 148 such that the carriage 152 is movable along the longitudinal axis 174 of the mirror assembly 100 with respect to the frame 144.

The mirror subassembly 154 includes a slider 156, a mirror tray 158, a mirror leaf 160, a handle 162, a friction hinge 164, a mirror 166, ball spring plungers 168, a striker plate 170, a cover panel 212 and a hinge cover 216. The slider 156 is a plate-like element having an upper surface 155 having apertures 157 for receiving carriage fasteners 176 to connect the slider 156 and the carriage 152 together. When connected, the slider 156 and the carriage 152 are linearly movable along the longitudinal axis 174 with respect to the frame 144 carrying the mirror tray 158 from a location within the frame 144 and within the furniture 106 to a location outside of the frame 144 and outside the furniture 106.

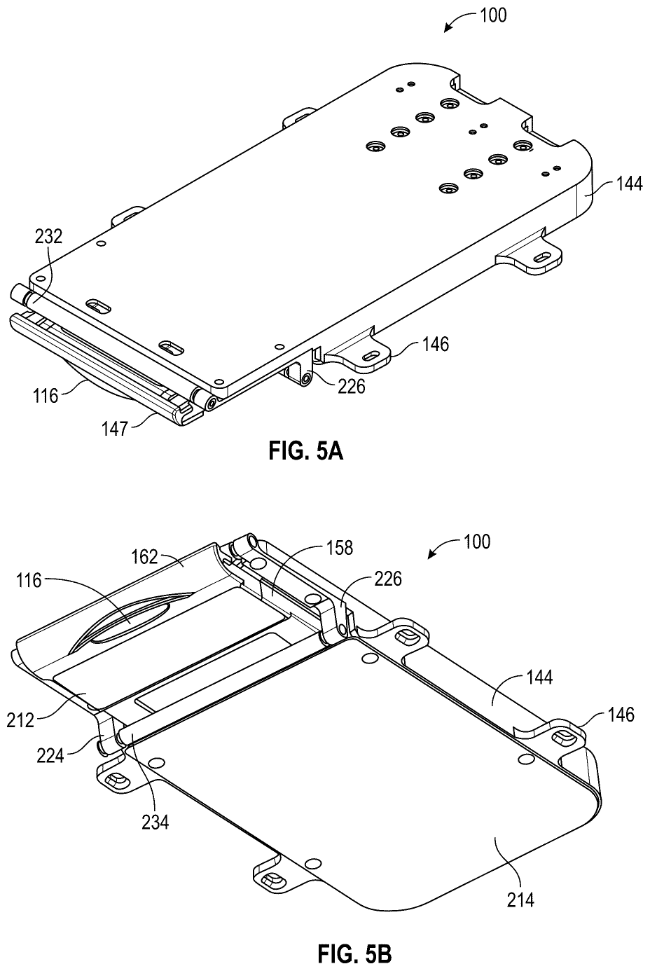

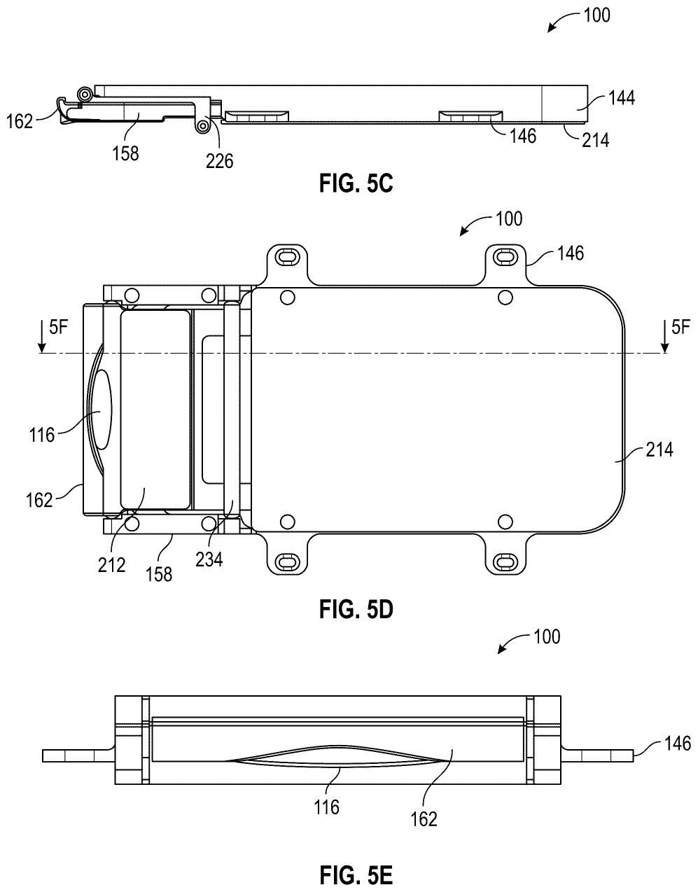

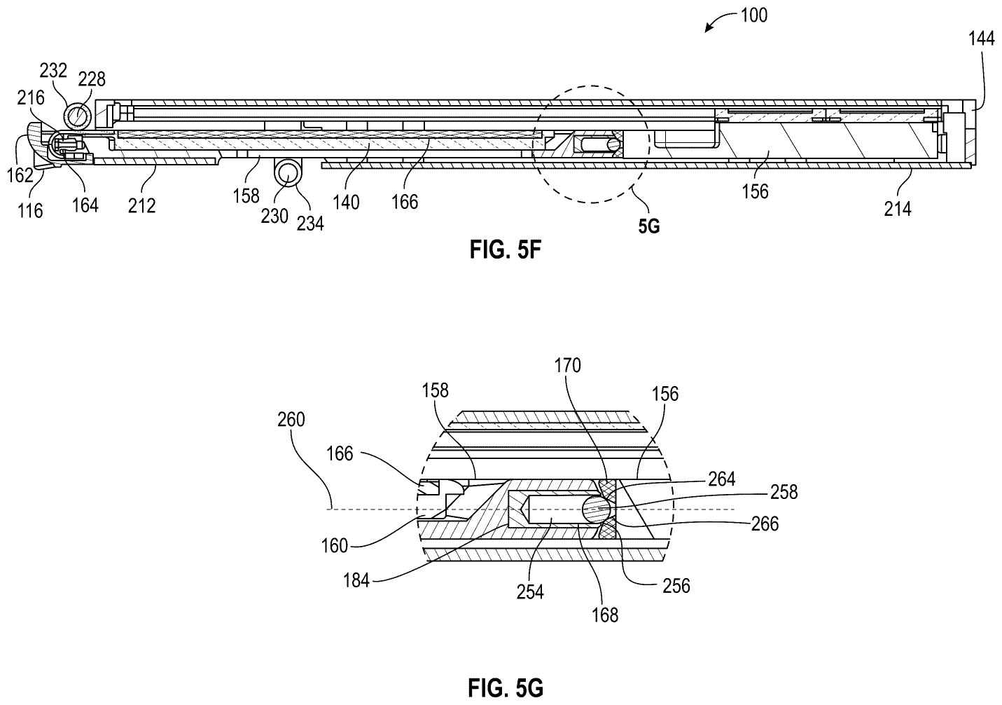

The mirror tray 158 is a frame-like element having an upper recess 182 that is sized and configured to receive a mirror leaf 160. A central opening 167 reduces the weight of the mirror frame 158. A rear end of the mirror tray 158 includes a plurality of ball spring plunger bores 184 sized and configured to receive ball spring plungers 168. A detail of the ball spring plunger 168 is shown in FIG. 5G. The front end of the mirror tray 158 includes apertures for connecting the mirror tray 158 to the handle 162. The mirror leaf 160 includes an upper surface having a rectangular recess 190 for receiving a correspondingly shaped rectangular mirror 166. The mirror 166 is planar having a length and a width and a reflective top surface 194. The mirror 166 is bonded into the rectangular recess 190 of the mirror leaf 160 with adhesive tape 186. The front end of the mirror leaf 160 is pivotally connected to the front end of the mirror tray 158. Transverse apertures 188 on the mirror leaf 160 are aligned between transverse apertures 200 on the mirror tray 158 and mirror leaf bolts 202 are inserted therethrough to connect the mirror leaf 160 to the mirror tray 158. The mirror leaf 160 is further connected to the mirror tray 158 with a friction hinge 164. The friction hinge 164 is connected to the front sides of the mirror leaf 160 and mirror tray 158 by passing friction hinge fasteners 204 through the friction hinge 164 and into apertures 206 on the mirror leaf 160 and into apertures 208 on the mirror tray 158. The friction hinge 164 permits the mirror leaf 160 to rotatably angulate with respect to the mirror tray 158 from a lie-flat position of approximately zero degrees to an upright position of approximately 100-135 degrees about a transverse axis 192 at the front of the mirror leaf 160 and mirror tray 158. When in the lie-flat position of approximately zero degrees, the top surface 194 of the mirror 166 and is substantially flush with the upper surface 196 of the mirror tray 158. In one variation, the maximum angle of the mirror leaf 160 with respect to the mirror tray 158 is approximately 106 degrees. The friction hinge 164 provides resistance to the pivoting motion of the mirror leaf 160 with respect to the mirror tray 158 allowing the mirror 166 to angulate and be fixed and held in an upright position at an angle desired by the passenger.

A handle 162 is connected to the front of the mirror tray 158 with handle fasteners 198 passed through handle apertures 210 on the bottom of the handle 162 and into corresponding apertures (not shown) on the bottom of the mirror tray 158. The handle 162 includes a first finger pull cavity 116 to facilitate pulling the mirror tray 158 out from the frame 144 along the longitudinal axis 174. A cover panel 212 is attached to the bottom of the mirror tray 158 to conceal the friction hinge 164 from the bottom side. A hinge cover 216 is configured to connect to the top of the handle 162 and mirror tray 158 to conceal the friction hinge 164 from the top side. The hinge cover 216 is provided with a placard 220 with instructions of use or other text for the passenger.

The mirror assembly 100 further includes a roller subassembly 222. The roller subassembly 222 includes a first roller bracket 224, a second roller bracket 226, an upper roller shaft 228, and a lower roller shaft 230, an upper roller sleeve 232, and a lower roller sleeve 234. The first roller bracket 224 is connected to the underside of the frame 144 with two fasteners 236 passed through apertures 238 and into bracket apertures 240 along a first side of the frame 144. The second roller bracket 226 is connected to the underside of the frame 144 with two fasteners 236 passed through apertures 242 and into bracket apertures 244 along a second side of the frame 144. When connected to the frame 144, an upper shaft opening 246a in the first roller bracket 224 is aligned with an upper shaft opening 246b in the second roller bracket 226 and a lower shaft opening 248a in the first roller bracket 224 is aligned with a lower shaft opening 248b in the second roller bracket 226. The upper shaft openings 246a, 246b are sized and configured to receive a upper roller shaft 228 and the lower shaft openings 248a, 248b are sized and configured to receive a lower roller shaft 230. The upper and lower roller shafts 228, 230 are solid metal cylinders having a circular cross-section with reduced diameters at the ends. The upper and lower roller sleeves 232, 234 are tubular and have a central bore that is sized and configured to receive corresponding upper and lower roller shafts 228, 230 and to cover the length of each of the upper and lower roller shafts 228, 230 minus the reduced diameter ends. The upper and lower roller shafts 228, 230 are inserted into their respective upper and lower roller sleeves 232, 234. The exposed reduced diameter ends of the upper roller shaft 228 are inserted into rubber washers 252 before being inserted into the upper shaft openings 246a, 246b and retained therein by a friction fit with the rubber washers 252. Similarly, the reduced diameter ends of the lower roller shaft 230 are inserted into rubber washers 252 before being inserted into the lower shaft openings 248a, 248b and retained therein by a friction fit with the rubber washers 252. The upper and lower roller shafts 228, 230 are connected such that they can rotate with respect to the frame 144. The middle portions of the upper and lower roller shafts 228, 230 that are covered by the upper and lower roller sleeves 232, 234, respectively, are located between the first roller bracket 224 and the second roller brackets 226. The upper roller shaft 228 and the lower roller shafts 230 are connected to the frame 144 such that they are parallel to the transverse axis 192 which is perpendicular to the longitudinal axis 174. Also, the upper and lower roller shafts 228, 230 are connected to define a distance along a vertical axis 250 between an outer diameter of the upper roller sleeve 232 and an outer diameter of the lower roller sleeve 234 that is approximately equal to or slightly greater than the thickness of the mirror tray 158 with the mirror leaf 160 and attached mirror 166 in a lie-flat configuration. The vertical axis 250 is perpendicular to a plane defined by the longitudinal axis 174 and transverse axis 192. The upper roller shaft 228 is located forward relative to the lower roller shaft 230 along the longitudinal axis 174. In particular, the upper roller shaft 228 is located outside the front end of the frame 144 as can be seen in FIGS. 5A and 5C and spaced apart from the lower roller shaft 230 along the longitudinal axis 174. The sleeved upper and lower roller shafts 228, 230 provide a support for the mirror subassembly 154 as it is translated along the longitudinal axis 174 from a stowed position to a partially deployed position and to a fully deployed position in which the mirror tray 158 is in a cantilevered position with respect to the slider 156. The sleeved upper and lower roller shafts 228, 230 also provide a low-friction, smooth glide tactile sensation for the passenger and assists in guiding and supporting the cantilevered extension of the mirror subassembly 154. The rubber upper roller sleeve 232 and lower roller sleeves 234 also provide for silent movement of the mirror subassembly 154 and prevents metal-on-metal contact and damage or scratching of the reflective top surface 194 of the mirror 166.

The front end 159 of the slider 156 includes transverse apertures 161 for connecting the slider 156 to the mirror tray 158. The back end of the mirror tray 158 is connected to the front end of the slider 156 using shoulder bolts 178 such that the connection forms a hinge allowing the mirror tray 158 to rotate with respect to the slider 156. The shoulder bolts 178 are covered with a screw cover 180 on either side of the hinged connection.

The connection of the mirror tray 158 to the slider 156 includes a breakaway connection. The breakaway connection is formed by a plurality of ball spring plungers 168 press-fitted into correspondingly sized ball spring plunger bores 184. Other methods of installing the ball spring plungers 168 into the body of the mirror tray 158 include adhesive or employing threaded ball spring plungers 168 that are threaded into the ball spring plunger bores 184. Each ball spring plunger 168 includes a cylindrical body 254 having an inner diameter sized and configured to receive a spring (not shown). The cylindrical body 254 has an open end 256 having an end diameter that is smaller than the inner diameter. A ball 258 having a ball diameter that is larger than the end diameter is captured within the cylindrical body 254 behind the reduced diameter of the open end 256 such that part of the ball 258 is exposed beyond the open end 256. Although a spherical ball 258 is shown, a partially spherical, curved, or angled tip can be employed as the protruding end of a plunger. The plunger has a cylindrical plunger body that is sized and configured to be retained in part behind the open end 256 and inside the cylindrical body 254. A spring is provided inside the cylindrical body 254 between the ball 258, or plunger body, and the inner floor of the cylindrical body 254. The spring biases the ball 258 or plunger body outwardly against the constricted open end 256. The ball 258, or plunger body, is movable along a longitudinal axis 260 of the ball spring plunger 168. An initial end force applied to the ball 258 along the longitudinal axis 260 that is sufficient to overcome the spring force of the spring will begin to compress the spring and allow the ball 258 to move down into the cylindrical body 254. The spring force applied to the ball 258 will increase as the spring is further compressed. Because the ball 258, or other plunger body, is curved or angled, an applied end force will have a force component along the longitudinal axis of ball spring plunger 168 to move the ball 258, or other plunger body, longitudinally even if the applied end force is not parallel to the longitudinal axis. When the end force is released, the spring will bias the ball 258 to its original position against the constricted open end 256.

The breakaway connection includes a striker plate 170 that is attached to the front end of the slider 156 with fasteners 262. The forward facing surface of the striker plate 170 includes a plurality of ball-receiving recesses 264 that are aligned with the ball spring plungers 168 housed in the mirror tray 158. Each ball-receiving recess 264 is sized and configured to receive the ball 258. When the ball 258 is engaged within the ball-receiving recess 264, rotation of the mirror tray 158 with respect to the slider 156 is prevented unless sufficient force is applied to overcome the combined spring force of all of the ball spring plungers 168. The striker plate 170 and ball spring plungers 168 form a breakaway hinge.

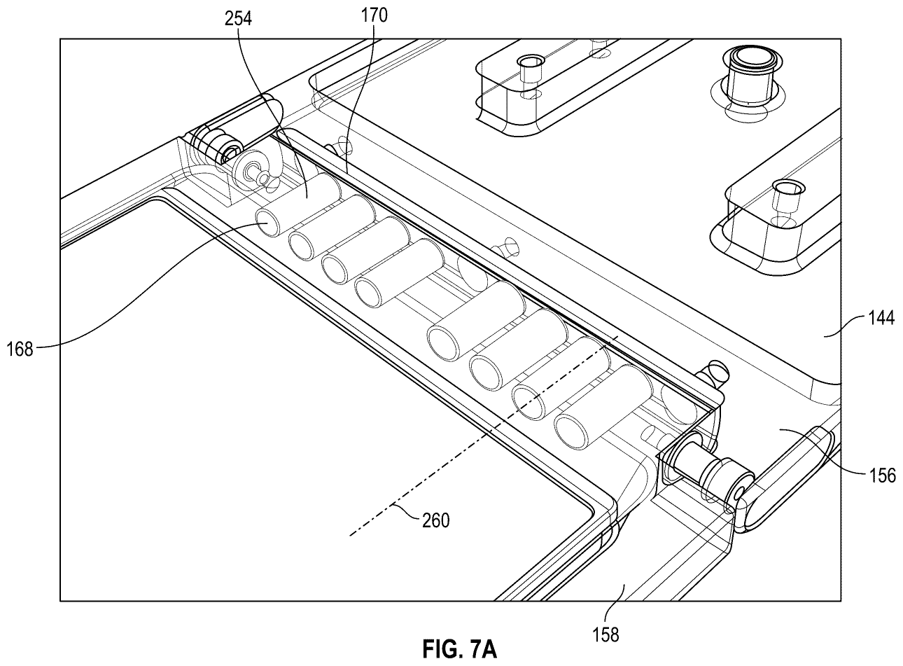

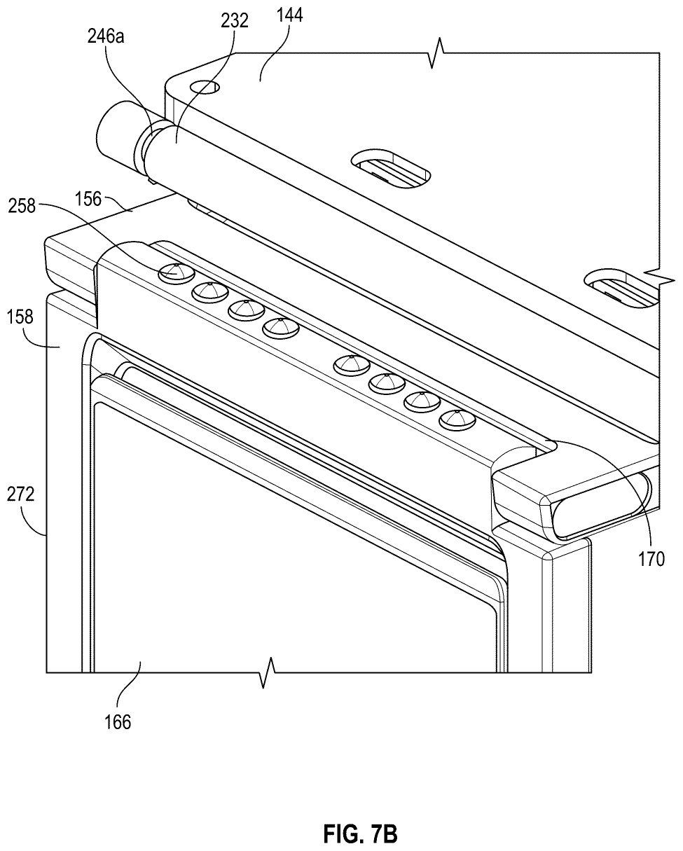

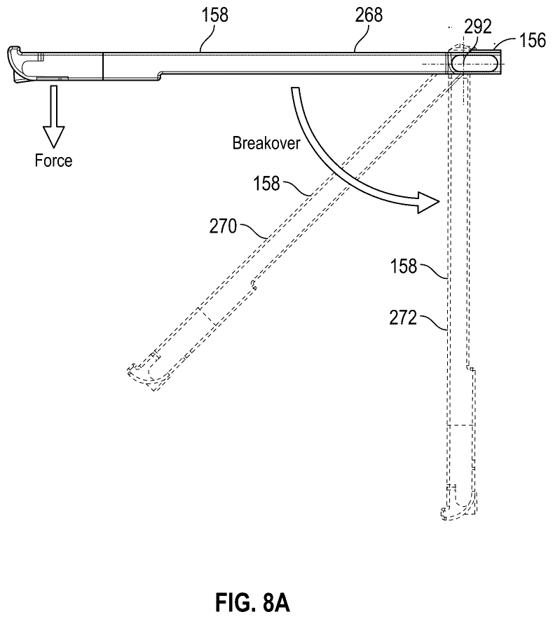

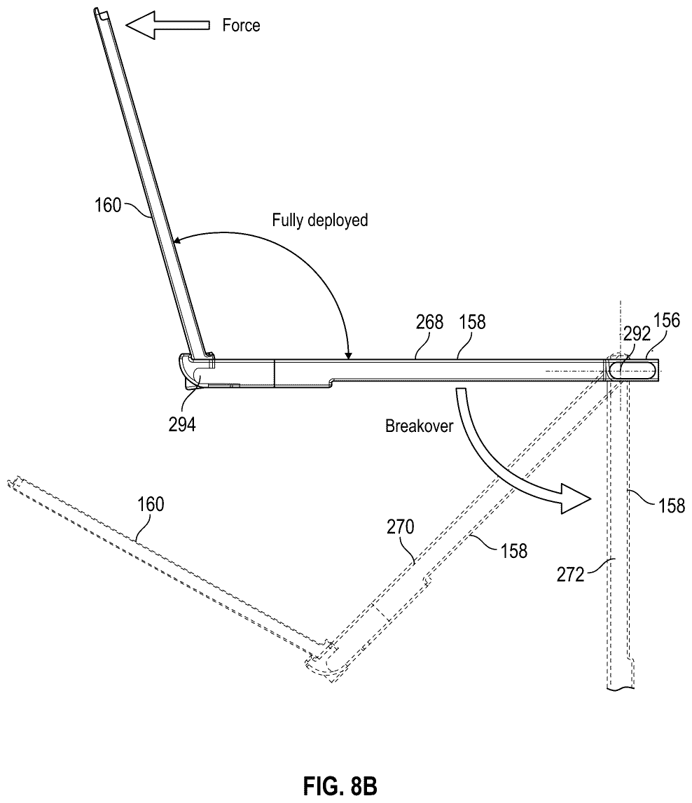

FIG. 7A shows a transparent sectional view of the breakover connection between the mirror tray 158 and slider 156 of the mirror assembly 100. Eight ball spring plungers 168 are shown with cylindrical bodies 254 embedded within the back end of the mirror tray 158. The balls 258 protrude beyond the back end of the mirror tray 158 and are resident within the ball-receiving recesses 264 of the striker plate 170 to lock the mirror tray 158 at a fixed angle in a horizontal cantilevered position parallel to the slider 156. The longitudinal axis 260 of ball spring plungers 168 are parallel to the longitudinal axis 174 of the mirror assembly 100. The weight of the cantilevered assembly including the mirror tray 158 in combination with the mirror leaf 160, mirror 166, handle 162, cover panel 212, hinge cover 216 and friction hinge 164 and associated fasteners and adhesives is not sufficient to cause the spring force of the eight ball spring plungers 168 to be overcome and the assembly remains locked in a cantilevered position with respect to the slider 156. In the cantilevered position, the mirror tray 158 is substantially coplanar with the slider 156. When a passenger accidentally applies a downward force to the mirror tray 158 in a downwardly direction as shown by the arrow in FIG. 8A that is sufficient to overcome the spring force of the ball spring plungers 168, the balls 258 will be pushed into their respective cylindrical bodies 254 in a direction outwardly from the ball-receiving recesses 264 and the mirror tray 158 will no longer be locked in a cantilevered position and will angulate downwardly as shown by the curved arrow in FIG. 8A indicating the direction of rotation about the breakaway hinge axis 292. FIG. 8A shows the cantilevered position 268 of the mirror tray 158 such as when the mirror tray 158 is extended and deployed with respect to the frame 144 with the mirror leaf 160 in a lie-flat orientation, an intermediate breakover position 270 of the mirror tray 158 in which the mirror tray 158 is at a descending angle, and a full breakover position 272 in which the mirror tray 158 is deflected approximately 90 degrees and perpendicular to the slider 156. FIG. 7B shows the mirror tray 158 in a full breakover position 272 exposing the balls 258 of the ball spring plungers 168.

FIG. 8B illustrates the mirror leaf 160 in a deployed mirror position in which the mirror leaf 160 is angulated approximately 106 degrees with respect to the mirror tray 158 around a mirror leaf axis 294. In FIG. 8B, the mirror assembly 100 is in a fully deployed configuration with the mirror tray 158 in a deployed tray position extended longitudinally from the frame 144 and in a cantilevered position 268 with respect to the slider 156 and the mirror leaf 160 in a deployed mirror position rotated into an upright position for use of the mirror 166. The force arrow in FIG. 8B shows an abuse load being applied to the deployed mirror leaf 160 along the longitudinal axis 174. FIG. 8B illustrates a force applied to a deployed mirror leaf 160 causing activation of the breakover feature freeing the mirror tray 158 to rotate together with the deployed mirror leaf 160 with respect to the slider 156 as indicated by the curved breakover direction arrow into an intermediate breakover position 270 and further rotated into a full breakover position 272 in which the mirror tray 158 is hanging approximately 90 degrees with respect to the slider 156. In the exemplary mirror assembly 100 configuration, the breakaway hinge axis 292 is parallel to the mirror leaf axis 294. The breakaway hinge axis 292 is spaced apart from the mirror leaf axis 294 along the longitudinal axis 174.

The breakover connection between the mirror tray 158 and slider 156 advantageously addresses an abuse load situation wherein a passenger accidentally exerts a force onto the assembly in a deployed tray position and/or or deployed mirror position. The breakover function not only prevents damage to the mirror assembly 100 that would require its repair or replacement, but also, advantageously allows the mirror assembly 100 to be re-set into a cantilevered position and re-stowed. To reset the mirror assembly 100 from a hanging breakover position into a re-stowed position, the passenger or a crew member can easily lift the hanging mirror tray 158 from any one of the breakover positions and rotate it upwardly with respect to the slider 156 until the balls 258 of the ball spring plungers 168 ramp over the detent surfaces 266 of the ball-receiving recesses 264 of the striker plate 170. The detent surfaces 266 will deflect the balls 258 into their respective cylindrical bodies 254 and with continued rotation the springs of the ball spring plungers 168 will bias the balls 258 snapping them into their respective ball-receiving recesses 264 to again lock the mirror tray 158 into a cantilevered position 268. The mirror leaf 160 is rotated into its lie-flat orientation before or after re-engagement of the ball spring plungers 168 and the mirror tray 158 is pushed longitudinally with respect to the frame 144 into a retracted and stowed position with respect to the support structure 101. When the mirror tray 158 is reset from a breakover position, the user will experience a tactile sensation of the ball spring plungers 168 snapping into the striker plate 170 and cantilevered position. The use of ball spring plungers 168 is one way of providing a breakover function. Other implementations in lieu of ball spring plungers 168 include the use of a friction hinge, a spring-loaded blade, or other alternatives to ball spring plungers 168 known to a person having ordinary skill in the art.

An advantage of the breakover feature is that a deployed mirror leaf 160 and mirror tray 158 can withstand an abuse load without breaking its functionality and be safely restowed. This advantage is particularly important to make the mirror assembly 100 compliant with aircraft safety standards and egress rules in the event of an emergency or for taxi, take-off, and landing (TTL). In the event of an emergency or for TTL, tray tables, stowage doors, and the like, in particular, ones that extend or are deployed toward the passenger seat and/or into the passenger egress path must be stowed or closed so that the passenger seat and egress path is clear and safe and that no objects or movable cabin furniture or amenity impede the passenger's safe exit. Aircraft safety standards for certain cabin items, such as tray tables and suite privacy doors, certify acceptable loads so that an average passenger can close or move the item out of the way. Accordingly, the breakover function of the mirror assembly 100 swings down out of the way when a certain abuse load is reached that is sufficient to overcome the spring force and resistance configuration with respect to type, number, and location of the ball spring plungers 168 employed in the mirror assembly 100. A ball spring plunger 168 having a spring with a higher spring constant will be stiffer and require a higher force to compress the spring. Hence, ball spring plungers 168 are selected to provide a desired breakaway force for the safety of the passenger. For example, ball spring plungers 168 are selected so that the mirror tray 158 will not breakaway under its own weight or from loads applied that are considered normal for the use and operation of the mirror assembly 100 but will breakaway under a load applied by an adult or child passenger seeking to clear an exit pathway or considered excessive for normal use and operation of the mirror assembly 100. Also, the breakaway load is selected to be smaller than a load that would cause damage or deform components of the mirror assembly 100 to the extent that the mirror could not be restowed, or that would disable the breakaway function. Although eight ball spring plungers 168 are shown in the figures, fewer or more ball spring plungers 168 can be employed to effect a particular abuse load limit. For example, if the abuse load limit is too high with eight ball spring plungers 168, fewer or different ball spring plungers 168 can be used. An exemplary abuse load limit is any load over approximately 5-10 pound-force. Another exemplary abuse load limit is any load over approximately 15 pound-force. To provide safe egress in the case of an immediate emergency, the mirror assembly 100 can be quickly and easily deflected into a hanging breakaway position to clear an exit pathway when there is no time to re-stow the mirror tray 158. Alternatively, to clear an exit pathway in a case of a non-emergency, such as for TTL, the mirror assembly can be advantageously and safely restowed from both a deployed position and a breakaway position.

Furthermore, the implementation of the breakover feature employing ball spring plungers 168 is provided within a mirror assembly 100 having a small, thin-dimensioned package. Therefore, the mirror assembly 100 can find application and be installed in similarly thin-dimensioned locations such as a tabletop, upper console, or other low-profile locations in furniture throughout the cabin. In one example, the thickness of the mirror assembly 100 along the vertical axis 250 is approximately one inch. In this example, the thickness of the mirror tray 158 along the vertical axis 250 is approximately one half inch. The ball spring plungers 168 embedded into an end of the mirror tray 158 are selected to have a diameter of less than approximately one half inch. In another example, the ball spring plungers 168 are approximately one quarter inch in diameter or smaller. The vertical package dimension of the mirror assembly 100 advantageously allows its installation in vertically restricted locations of an aircraft cabin. This limitation drives selection of the highest force ball spring plungers 168 for the package size in order to provide an abuse load that is not too small to prevent the mirror tray 158 from breaking over too frequently during normal use.

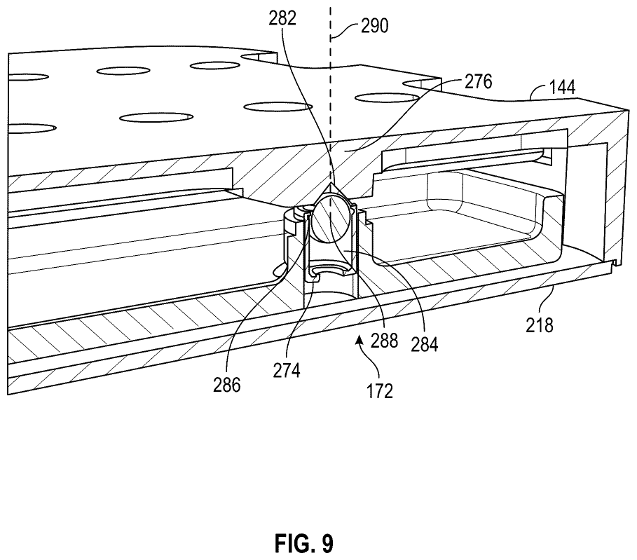

The mirror assembly 100 includes at least one slider detent subassembly 172 configured to prevent the mirror subassembly 154 from inadvertently sliding out with respect to the frame 144 and to keep the mirror subassembly 154 safely stowed within the support structure 101. With continued reference to FIG. 4 and with additional reference to FIG. 9, the slider detent subassembly 172 includes one or more ball spring plungers 274. The ball spring plungers 274 are fixed inside the body of the slider 156 and configured to engage corresponding striker blocks 276 that are connected to the frame 144. The slider 156 includes three cylindrical ball spring plunger bores 278 aligned in a row transverse to the longitudinal axis 174 of the frame 144. The ball spring plunger bores 278 are size and configured to receive correspondingly sized ball spring plungers 274 in a press-fit engagement. Three individual striker blocks 276, each having a ball-receiving recess 282 are mounted to the underside and close to the rear end of the frame 144 via fasteners 280. Each of the ball spring plungers 274 include a cylindrical body 284 having an open end 286 with a reduced inner diameter relative to the inner diameter of the cylindrical body 284. A ball 288 or other plunger body is retained between the open end 286 and a spring (not shown) located inside the cylindrical body 284. As explained above, the ball 288 is biased against the constricted open end 286 by a spring exerting a force onto the ball 288 which in part protrudes beyond the open end 286 to engage an aligned ball-receiving recess 282 on the striker block 276. The ball-receiving recess 282 is conical in shape as shown in FIG. 9B; however, any appropriate ball-receiving recess 282 that provides an interference surface size and configured to retain the ball 288 within the ball-receiving recess 282 until a sufficient force, perpendicular to a longitudinal axis 290 of the ball spring plunger 274, is applied to compress the spring and move the ball 288 deeper into the cylindrical body 284 such that the ball 288 clears the interference surface to permit translation of the mirror subassembly 154 relative to the frame 144 in a longitudinal direction 174. The slider detent subassembly 172 keeps the slider 156 temporarily locked with respect to the frame 144. The lock is released by the application of force to the slider 156 via the connected mirror tray 158 when it is pulled by the handle 162 so that the mirror subassembly 154 can slide freely into deployment. When returning the mirror subassembly 154 into a stowed position, a passenger will push the handle 162 longitudinally to a completely stowed position. The ball spring plungers 274 are aligned to be engaged in a locked position with respect to the striker blocks 276 when the mirror tray 158 is in a completely closed and stowed position with respect to the frame 144 with the front end of the handle 162 flush with respect to cabin furniture 106 in which the mirror assembly 100 is installed.

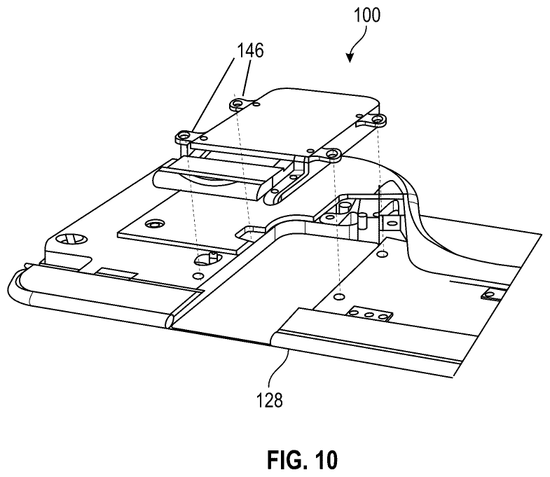

The mirror assembly 100 includes a cover 214 attached to the bottom of the frame 144 with fasteners 218. The mirror assembly 100 as a unit is installed into a cabin furniture 106 such as tabletop 128 with fasteners passed through the mounting flanges 146 on the frame as shown in FIG. 10.

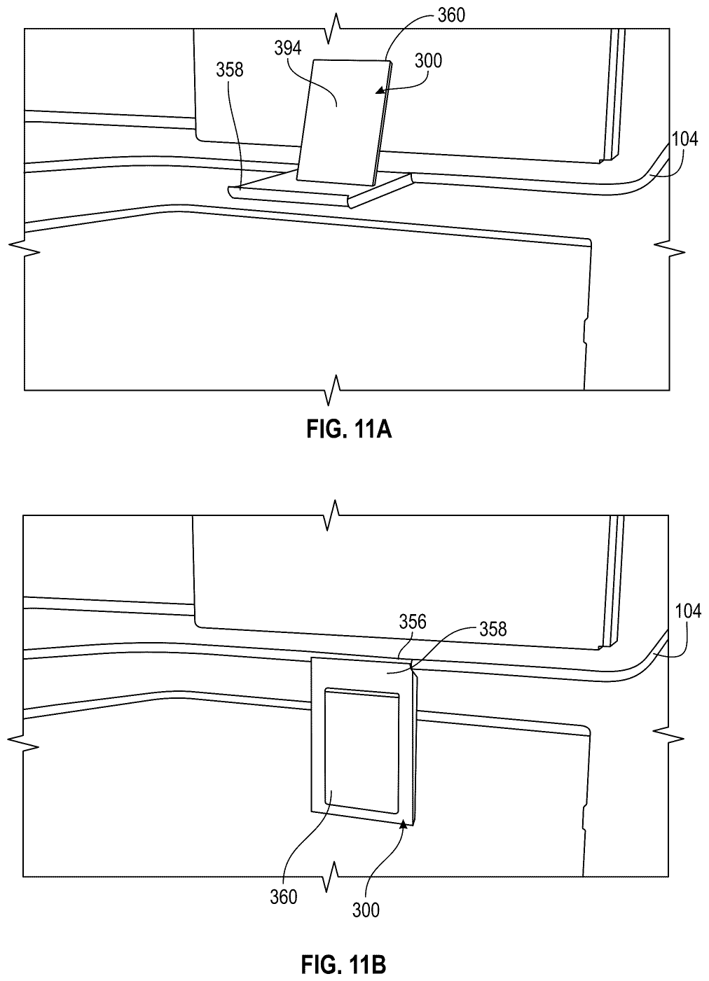

FIGS. 11A-11B show an alternative mirror assembly 300 installed in an upper console 104 adjacent to a passenger seat. FIG. 11A illustrates the mirror assembly 300 in a fully deployed position with a mirror leaf 360 in a deployed mirror position angulated from its lie-flat position with respect to the mirror tray 358. In this variation, a back end of the mirror leaf 360 is rotatably connected to the mirror tray 358 near the back end of the mirror tray 358. A mirror 394 is located on the underside of the mirror leaf 360 such that when the mirror leaf 369 is unfolded at a hinge at the back end, the mirror 394 is viewable by the passenger. In this variation, the mirror 394 is protected by facing down when in an undeployed mirror position. FIG. 11B illustrates the mirror assembly 300 of FIG. 11A in a breakover position in which the mirror tray 358 is rotated downwardly approximately 90 degrees from an abuse load that reached an abuse load limit. The breakover connection between the mirror tray 358 and slider 356 is arranged in the same way described above using ball spring plungers 274. The mirror tray 358 is returned to a cantilevered position with respect to the slider 356 by rotating the mirror tray 358 upwardly into a horizontal position to re-engage the ball spring plungers 274 with the striker plate 170 to permit the mirror subassembly 154 to be moved longitudinally into a stowed position with respect to the upper console 104.

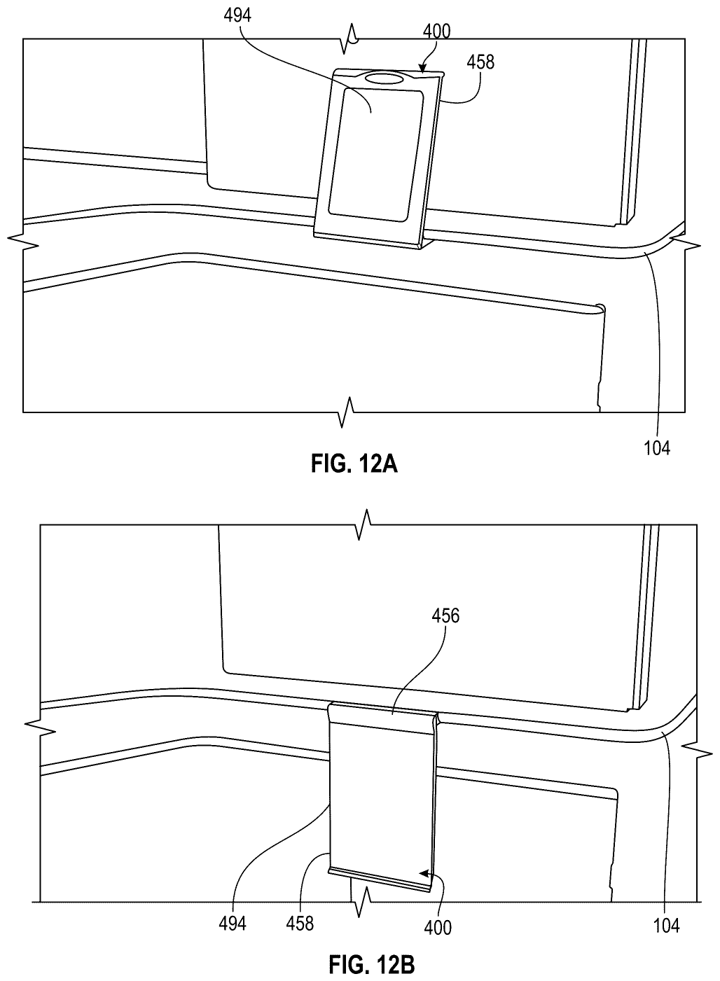

FIGS. 12A-12B show another alternative mirror assembly 400 installed in an upper console 104 adjacent to a passenger seat. FIG. 12A illustrates the mirror assembly 400 in a fully deployed position. In this variation, a mirror 494 is connected to the underside of a mirror tray 458. When the mirror tray 458 is rotated upwardly with respect to a slider 456, the mirror 494 is viewable by the passenger. FIG. 12B illustrates the mirror assembly 400 of FIG. 12A in a breakover position in which the mirror tray 458 is in a hanging breakover position as a result of an abuse load application. The breakover connection between the mirror tray 458 and slider 456 is formed in the same way described above using ball spring plungers 274. In this variation, there is no mirror leaf that rotates with respect to mirror tray 458 to deploy the mirror 494 into a deployed mirror position. The mirror tray 494 can be reset from a breakover position by rotating it upwardly such that the mirror tray 158 is horizontal and parallel to the slider 456 and upper console 104. When rotated, the ball spring plungers 274 click into a locked deployed tray position in which the mirror tray 494 is again cantilevered and able to slide back with respect to the frame 144 into a stowed position.

### EXAMPLES

Example one includes an assembly comprising a housing having an opening, the housing configured to attach to a support structure, a tray connected to the housing and configured to slide laterally through the opening between a stowed tray position and a deployed tray position, and a mirror connected to the tray and configured to rotate relative to the tray, when in the deployed tray position, from a stowed mirror position to a deployed mirror position in which the mirror is positioned at an angle with respect to the tray.

Example two includes the assembly of Example one, and further includes a slider connected between the tray and the housing and configured to slide relative to the housing, the tray connected to the slider at a breakaway connection and being cantilevered with respect to the slider in the deployed tray position, the tray being movable from the deployed tray position to a breakaway tray position relative to the slider at the breakaway connection upon application of an abuse load to the tray.

Example three includes the assembly of Example two, wherein the breakaway connection includes at least one ball spring plunger connected to one of the tray and the slider and a striker plate that is connected to other one of the tray and the slider to lock the tray in the deployed tray position in which the at least one ball spring plunger is engaged with the striker plate.

Example four includes the assembly of Example two wherein the tray is angled with respect to the slider in the breakaway tray position.

Example five includes the assembly of Example two, wherein, when in the breakaway tray position, the tray is returnable to the deployed tray position.

Example six includes the assembly of Example two, wherein the tray is coplanar with the slider in the deployed tray position.

Example seven includes the assembly of Example two, wherein the breakaway connection is located between a front end of the slider and a back end of the tray such that the breakaway connection is proximal to the opening of the housing when in the deployed tray position.

Example eight includes the assembly of Example one, wherein the mirror has a reflective surface facing away from the tray when in the stowed mirror position.

Example nine includes the assembly of Example one, wherein the mirror is located outside of the housing when in the deployed tray position.

Example ten includes an assembly comprising a housing connected to a support structure, a tray connected to the housing and configured to slide laterally relative to the housing between a stowed tray position and a deployed tray position, and a breakaway hinge coupling together the housing and the tray, wherein the breakaway hinge is operable to release the tray from the deployed tray position to a hanging breakaway tray position upon application of an abuse load to the tray such that at least a portion of the tray hangs downwardly relative to the housing.

Example eleven includes the assembly of Example ten, wherein the tray is movable from the stowed tray position to the deployed tray position along a direction parallel to a longitudinal axis and the tray is angled relative to the housing in the hanging breakaway tray position.

Example twelve includes the assembly of Example ten, wherein the breakaway hinge is a friction hinge configured to hold the tray in the deployed tray position.

Example thirteen includes the assembly of Example ten, wherein the support structure is a vehicle cabin installation, furniture, console, or tabletop.

Example fourteen includes the assembly of Example ten, wherein the tray is located inside the support structure when in the stowed tray position such that an outer surface of the tray is flush with an outer surface of the support structure.

Example fifteen includes the assembly of Example ten, and further includes a mirror connected to the tray and configured to rotate relative to the housing.

Example sixteen includes an assembly comprising at least one passenger seat, a support structure adjacent to the passenger seat defining an egress pathway between the passenger seat, and at least one breakaway tray assembly connected to the support structure, the breakaway tray assembly comprising a tray movable from a stowed tray position to a deployed tray position in which the tray extends into the egress pathway, and a breakaway hinge operable to release the tray from the deployed tray position to a hanging breakaway tray position upon application of an abuse load to the tray.

Example seventeen includes the assembly of Example sixteen, wherein, when in the hanging breakaway tray position, the tray hangs downwardly and extends laterally less into the egress pathway relative to the deployed tray position to facilitate a passenger's egress.

Example eighteen includes the assembly of Example sixteen, wherein the at least one breakaway tray assembly comprises a housing attached to the support structure, and wherein the tray is laterally slidable relative to the housing such that the tray is hidden when in the stowed tray position and visible when in the deployed tray position, and wherein the tray extends towards the passenger seat when in the deployed tray position for passenger use.

Example nineteen includes the assembly of Example sixteen, wherein the support structure is a tabletop that includes a first breakaway tray assembly and a second breakaway tray assembly.

Example twenty includes the assembly of Example sixteen, wherein the at least one passenger seat forms part of a passenger suite configured to be installed in a cabin of a vehicle, and wherein the support structure is a tabletop having a planar tabletop surface, and wherein the at least one breakaway tray assembly comprises a vanity mirror that is movable, when in the deploy tray position, by a passenger to a position transverse relative to the planar tabletop surface.

Those skilled in the art will appreciate from the foregoing description that the broad techniques of the examples of the present disclosure can be implemented in a variety of forms. Therefore, while the examples of this disclosure have been described in connection with particular examples thereof, the true scope of the examples of the disclosure should not be so limited since other modifications will become apparent to the skilled practitioner upon a study of the drawings, specification, and following claims.

What is claimed:

1. An assembly, comprising:
a housing having an opening, the housing configured to attach to a support structure;
a tray connected to the housing and configured to slide laterally through the opening between a stowed tray position and a deployed tray position; and
a mirror connected to the tray and configured to rotate relative to the tray, when in the deployed tray position, from a stowed mirror position to a deployed mirror position in which the mirror is positioned at an angle with respect to the tray.

2. The assembly of claim 1, further including a slider connected between the tray and the housing and configured to slide relative to the housing; the tray connected to the slider at a breakaway connection and being cantilevered with respect to the slider in the deployed tray position; the tray being movable from the deployed tray position to a breakaway tray position relative to the slider at the breakaway connection upon application of an abuse load to the tray.

3. The assembly of claim 2, wherein the breakaway connection includes at least one ball spring plunger connected to one of the tray and the slider and a striker plate that is connected to other one of the tray and the slider to lock the tray in the deployed tray position in which the at least one ball spring plunger is engaged with the striker plate.

4. The assembly of claim 2, wherein the tray is angled with respect to the slider in the breakaway tray position.

5. The assembly of claim 2, wherein when in the breakaway tray position, the tray is returnable to the deployed tray position.

6. The assembly of claim 2, wherein the tray is coplanar with the slider in the deployed tray position.

7. The assembly of claim 2, wherein the breakaway connection is located between a front end of the slider and a back end of the tray such that the breakaway connection is proximal to the opening of the housing when in the deployed tray position.

8. The assembly of claim 1 wherein the mirror has a reflective surface facing away from the tray when in the stowed mirror position.

9. The assembly of claim 1, wherein the mirror is located outside of the housing when in the deployed tray position.

10. An assembly, comprising:
a housing connected to a support structure;
a tray connected to the housing and configured to laterally slide relative to the housing between a stowed tray position and a deployed tray position; and
a breakaway hinge coupling together the housing and the tray, wherein the breakaway hinge is operable to release the tray from the deployed tray position to a hanging breakaway tray position upon application of an abuse load to the tray such that at least a portion of the tray hangs downwardly relative to the housing.

11. The assembly of claim 10, wherein the tray is movable from the stowed tray position to the deployed tray position along a direction parallel to a longitudinal axis and the tray is angled relative to the housing in the hanging breakaway tray position.

12. The assembly of claim 10, wherein the breakaway hinge is a friction hinge configured to hold the tray in the deployed tray position.

13. The assembly of claim 10, wherein the support structure is a vehicle cabin installation, furniture, console, or tabletop.

14. The assembly of claim 10, wherein the tray is located inside the support structure when in the stowed tray position such that an outer surface of the tray is flush with an outer surface of the support structure.

15. The assembly of claim 10, further including a mirror connected to the tray and configured to rotate relative to the housing.

16. An assembly, comprising:
at least one passenger seat;
a support structure adjacent to the passenger seat defining an egress pathway between the passenger seat; and
at least one breakaway tray assembly connected to the support structure; the breakaway tray assembly comprising:
a tray movable from a stowed tray position to a deployed tray position in which the tray extends into the egress pathway; and
a breakaway hinge operable to release the tray from the deployed tray position to a hanging breakaway tray position upon application of an abuse load to the tray.

17. The assembly of claim 16, wherein, when in the hanging breakaway tray position, the tray hangs downwardly and extends laterally less into the egress pathway relative to the deployed tray position to facilitate a passenger's egress.

18. The assembly of claim 16, at least one breakaway tray assembly comprises a housing attached to the support structure and wherein the tray is laterally slidable relative to the housing such that the tray is hidden when in the stowed tray position and visible when in the deployed tray position, and wherein the tray extends towards the passenger seat when in the deployed tray position for passenger use.

19. The assembly of claim 16, wherein the support structure is a tabletop that includes a first breakaway tray assembly and a second breakaway tray assembly.

20. The assembly of claim 16, wherein the at least one passenger seat forms part of a passenger suite configured to be installed in a cabin of a vehicle, and wherein the support structure is a tabletop having a planar tabletop surface, and wherein the at least one breakaway tray assembly comprises a vanity mirror that is movable, when in the deploy tray position, by a passenger to a position transverse relative to the planar tabletop surface.
